(19) United States
(12) Patent Application Publication
(10) Pub. No.: US 2020/0192485 A1
(43) Pub. Date: Jun. 18, 2020

(54) GAZE-BASED GESTURE RECOGNITION

(71) Applicant: Lenovo (Singapore) Pte. Ltd., Singapore (SG)

(72) Inventors: Russell Speight VanBlon, Raleigh, NC (US); Kevin Wayne Beck, Raleigh, NC (US); Thorsten Peter Stremlau, Morrisville, NC (US)

(21) Appl. No.: 16/217,920

(22) Filed: Dec. 12, 2018

(51) Int. Cl. G06F 3/01

(52) U.S. Cl. CPC G06F 3/017; G06F 3/012; G06F 3/013

(57) ABSTRACT

One embodiment provides a method, including: detecting, using at least one sensor of an information handling device, a gaze location of a user; activating, responsive to detecting that the gaze location is directed at a predetermined location, a gesture recognition module associated with the information handling device; identifying, using the gesture recognition module, at least one gesture provided by the user; and performing at least one action based on the at least one gesture. Other aspects are described and claimed.

### BACKGROUND

Information handling devices (“devices”), for example smart phones, tablet devices, stand-alone digital assistant devices, laptop and personal computers, and the like, are capable of receiving and processing gesture inputs from one or more users. As an example, one or more sensors on a device may be active to detect user motions. Responsive to the detection of a user motion that matches a recognized gesture input command, the device may perform a corresponding function based on the gesture input command.

### BRIEF SUMMARY

In summary, one aspect provides a method, comprising: detecting, using at least one sensor of an information handling device, a gaze location of a user; activating, responsive to detecting that the gaze location is directed at a predetermined location, a gesture recognition module associated with the information handling device; identifying, using the gesture recognition module, at least one gesture provided by the user; and performing at least one action based on the at least one gesture.

Another aspect provides an information handling device, comprising: at least one sensor; a gesture recognition module; a processor; a memory device that stores instructions executable by the processor to: detect a gaze location of a user; activate, responsive to detecting that the gaze location is directed at a predetermined location, the gesture recognition module; identify, using the gesture recognition module, at least one gesture provided by the user; and perform at least one action based on the at least one gesture.

A further aspect provides a product, comprising: a storage device that stores code, the code being executable by a processor and comprising: code that detects a gaze location of a user; code that activates, responsive to detecting that the gaze location is directed at a predetermined location, a gesture recognition module; code that identifies, using the gesture recognition module, at least one gesture provided by the user; and code that performs at least one action based on the at least one gesture.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example of information handling device circuitry.

FIG. 2 illustrates another example of information handling device circuitry.

FIG. 3 illustrates an example method of performing an action based on a gesture of an identified user.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

Gesture inputs are often utilized when the provision of physical input (e.g., touch input, keyboard input, mouse input, etc.) or voice input is inconvenient and/or impractical. For example, a user positioned away from a device and in a loud environment (e.g., a crowded room, etc.) may want to skip to the next song on a musical playlist. The user may be too far away from the device to provide physical input and the provision of audible input would likely be ineffective due to the noise levels in the current space. To overcome these obstacles, a user may direct a gesture command toward the device (e.g., a swipe motion of their hand, etc.) that, once detected, may instruct the device to skip to the next song.

As illustrated in the foregoing example, gesture input commands may be convenient to use in certain situations. However, conventional methods of detecting and processing gesture input commands are flawed. For instance, using the foregoing example, a gesture recognition module may be unable to adequately identify the user's gesture input command due to the motion created by many others in the user's space. Additionally or alternatively, the gesture recognition module may mistake the inadvertent motion made by another individual as the gesture input command. Furthermore, in order to capture the gesture input command, conventional gesture recognition modules are always-on. That is, conventional gesture recognition modules are continuously scanning for gesture input commands, which consumes a great deal of power.

Accordingly, an embodiment provides a method for activating a gesture recognition module of a device that may thereafter detect and process gesture inputs provided by a user. In an embodiment, a gaze location of a user may be detected. An embodiment may thereafter determine whether the gaze location corresponds to a predetermined location (e.g., a specific object, a specific direction, etc.) and, responsive to determining that it does, an embodiment may activate a gesture recognition module associated with the device. For example, an embodiment may activate a gesture recognition module responsive to determining that the gaze of the user is directed at the device. An embodiment may thereafter identify a gesture provided by the user and perform a corresponding function based on the gesture. Such a method may prevent users from inadvertently providing gesture inputs to a device.

The illustrated example embodiments will be best understood by reference to the figures. The following description is intended only by way of example, and simply illustrates certain example embodiments.

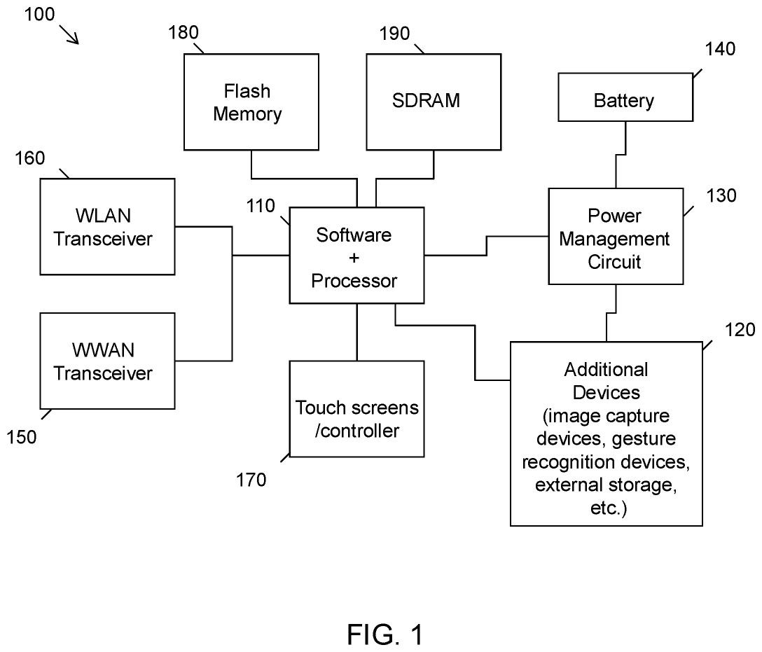

While various other circuits, circuitry or components may be utilized in information handling devices, with regard to smart phone and/or tablet circuitry 100, an example illustrated in FIG. 1 includes a system on a chip design found for example in tablet or other mobile computing platforms. Software and processor(s) are combined in a single chip 110. Processors comprise internal arithmetic units, registers, cache memory, busses, I/O ports, etc., as is well known in the art. Internal busses and the like depend on different vendors, but essentially all the peripheral devices (120) may attach to a single chip 110. The circuitry 100 combines the processor, memory control, and I/O controller hub all into a single chip 110. Also, systems 100 of this type do not typically use SATA or PCI or LPC. Common interfaces, for example, include SDIO and I2C.

There are power management chip(s) 130, e.g., a battery management unit, BMU, which manage power as supplied, for example, via a rechargeable battery 140, which may be recharged by a connection to a power source (not shown). In at least one design, a single chip, such as 110, is used to supply BIOS like functionality and DRAM memory.

System 100 typically includes one or more of a WWAN transceiver 150 and a WLAN transceiver 160 for connecting to various networks, such as telecommunications networks and wireless Internet devices, e.g., access points. Additionally, devices 120 are commonly included, e.g., an image sensor such as a camera, audio capture device such as a microphone, motion sensor, external storage device, etc. System 100 often includes one or more touch screens 170 for data input and display/rendering. System 100 also typically includes various memory devices, for example flash memory 180 and SDRAM 190.

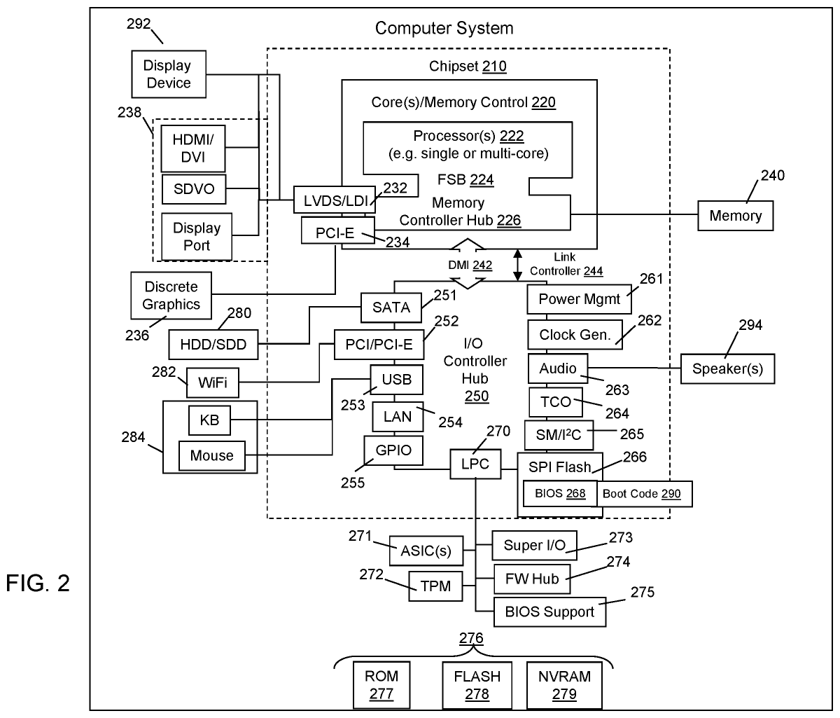

FIG. 2 depicts a block diagram of another example of information handling device circuits, circuitry or components. The example depicted in FIG. 2 may correspond to computing systems such as the THINKPAD series of personal computers sold by Lenovo (US) Inc. of Morrisville, N.C., or other devices. As is apparent from the description herein, embodiments may include other features or only some of the features of the example illustrated in FIG. 2.

The example of FIG. 2 includes a so-called chipset 210 (a group of integrated circuits, or chips, that work together, chipsets) with an architecture that may vary depending on manufacturer (for example, INTEL, AMD, ARM, etc.). INTEL is a registered trademark of Intel Corporation in the United States and other countries. AMD is a registered trademark of Advanced Micro Devices, Inc. in the United States and other countries. ARM is an unregistered trademark of ARM Holdings plc in the United States and other countries. The architecture of the chipset 210 includes a core and memory control group 220 and an I/O controller hub 250 that exchanges information (for example, data, signals, commands, etc.) via a direct management interface (DMI) 242 or a link controller 244. In FIG. 2, the DMI 242 is a chip-to-chip interface (sometimes referred to as being a link between a “northbridge” and a “southbridge”). The core and memory control group 220 include one or more processors 222 (for example, single or multi-core) and a memory controller hub 226 that exchange information via a front side bus (FSB) 224; noting that components of the group 220 may be integrated in a chip that supplants the conventional “northbridge” style architecture. One or more processors 222 comprise internal arithmetic units, registers, cache memory, busses, I/O ports, etc., as is well known in the art.

In FIG. 2, the memory controller hub 226 interfaces with memory 240 (for example, to provide support for a type of RAM that may be referred to as “system memory” or “memory”). The memory controller hub 226 further includes a low voltage differential signaling (LVDS) interface 232 for a display device 292 (for example, a CRT, a flat panel, touch screen, etc.). A block 238 includes some technologies that may be supported via the LVDS interface 232 (for example, serial digital video, HDMI/DVI, display port). The memory controller hub 226 also includes a PCI-express interface (PCI-E) 234 that may support discrete graphics 236.

In FIG. 2, the I/O hub controller 250 includes a SATA interface 251 (for example, for HDDs, SDDs, etc., 280), a PCI-E interface 252 (for example, for wireless connections 282), a USB interface 253 (for example, for devices 284 such as a digitizer, keyboard, mice, cameras, phones, microphones, storage, other connected devices, etc.), a network interface 254 (for example, LAN), a GPIO interface 255, a LPC interface 270 (for ASICs 271, a TPM 272, a super I/O 273, a firmware hub 274, BIOS support 275 as well as various types of memory 276 such as ROM 277, Flash 278, and NVRAM 279), a power management interface 261, a clock generator interface 262, an audio interface 263 (for example, for speakers 294), a TCO interface 264, a system management bus interface 265, and SPI Flash 266, which can include BIOS 268 and boot code 290. The I/O hub controller 250 may include gigabit Ethernet support.

The system, upon power on, may be configured to execute boot code 290 for the BIOS 268, as stored within the SPI Flash 266, and thereafter processes data under the control of one or more operating systems and application software (for example, stored in system memory 240). An operating system may be stored in any of a variety of locations and accessed, for example, according to instructions of the BIOS 268. As described herein, a device may include fewer or more features than shown in the system of FIG. 2.

Information handling device circuitry, as for example outlined in FIG. 1 or FIG. 2, may be used in devices such as smart phones, tablets, independent digital assistant devices, personal computer devices generally, and/or electronic devices that comprise a gesture recognition module and are capable of detecting a direction of user gaze, identifying gesture input, and performing an action based on the gesture input. For example, the circuitry outlined in FIG. 1 may be implemented in a tablet or smart phone embodiment, whereas the circuitry outlined in FIG. 2 may be implemented in a laptop embodiment.

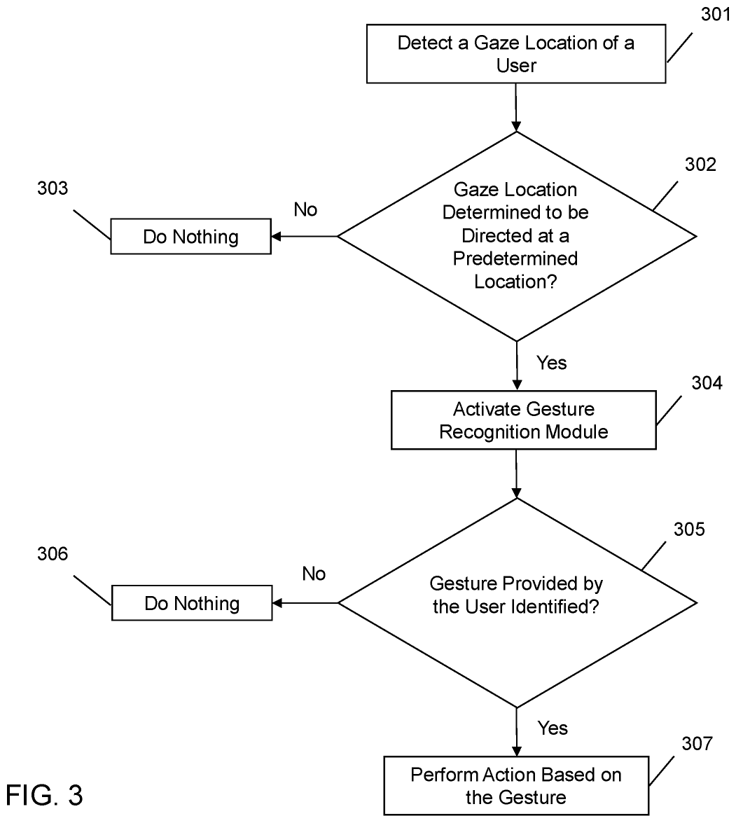

Referring now to FIG. 3, an embodiment may activate a gesture recognition module responsive to identifying that a user's gaze is focused on a predetermined location and thereafter perform an action correspondent to a recognized gesture provided by the user. At 301, an embodiment may detect a gaze location of a user. In the context of this application, a gaze location of a user may refer to a direction in which a user's eyes, or head, are turned or focused. In an embodiment, the detection of the gaze location may be conducted by at least one sensor, e.g., an image capture device (e.g., a static image camera, etc.), a video capture device (e.g., a video camera, etc.), a range imaging device, a three-dimensional (“3D”) scanning device, a combination thereof, and the like integrally or operatively coupled to the device. As an example implementation of the detection method, an embodiment may capture an image of a user using one or more cameras and thereafter analyze the image (e.g., using one or more conventional image analyze techniques, using one or more conventional eye tracking techniques, etc.) to identify the direction the user is staring and/or to identify an object a user is staring at.

In an embodiment, the at least one sensor may be configured to always attempt to detect a gaze location of a user. Stated differently, the at least one sensor is always active and consuming power to perform detection functions. Alternatively, in another embodiment, the at least one sensor may only activate responsive to the satisfaction of a predetermined condition. For example, the at least one sensor may only activate responsive to receiving an explicit user activation input or when the device has received an indication that a user is within a predetermined proximity to the device.

At 302, an embodiment may determine whether the gaze location of the user is directed at a predetermined location. In an embodiment, the predetermined location may be associated with a portion of the device (e.g., a display screen of the device, a camera lens of the device, etc.). Alternatively, the predetermined location may be associated with a general location (e.g., the general direction the device is located in, etc.) or another device. Responsive to determining, at 302, that the gaze location is not directed at the predetermined location, an embodiment may, at 303, do nothing. More particularly, an embodiment may ignore any type of user inputs provided to the device. Conversely, responsive to determining, at 302, that the gaze location is directed at the predetermined location, an embodiment may, at 304, activate a gesture recognition module associated with the device. In the context of this application, a gesture recognition module may be a hardware or software unit of the device that is capable of receiving and processing non-audible, gesture inputs provided by a user. In an embodiment, the gesture recognition module may remain active for a predetermined amount of time (e.g., 5 seconds, 10 seconds, etc.) or until a gesture input is identified.

As a non-limiting example implementation of the foregoing, responsive to determining that a user's gaze is directed at a display screen of the device, an embodiment may thereafter activate a gesture recognition module associated with the device that is capable of receiving and processing gesture inputs provided by the user. In an embodiment, the gesture recognition module may not be activated until an embodiment determines that a user's gaze is directed at the predetermined location for a predetermined amount of time (e.g., 5 seconds, 10 seconds, etc.). Such an embodiment may prevent unintentional activation of the gesture recognition module (e.g., in situations where a user only glances at the predetermined location without having the intention to provide gesture input, in situations where a disabled user cannot control the motion of all parts of their body, etc.).

In an embodiment, a notification may be provided to the user responsive to the activation of the gesture recognition module. The notification may serve as an explicit indication to the user that the gesture recognition module is active and ready to receive and process gesture inputs from the user. In an embodiment, the notification may be a visual notification in which a visual characteristic of the device is adjusted. For example, an embodiment may: provide a textual message on a display screen of the device or another device that the gesture recognition module is active, display an animation or video indicating that the gesture recognition module is active, emit one or more flashes, and the like. In another embodiment, the notification may be an audible notification in which an audible sound is emitted (e.g., from one or more audible output devices such as speakers, etc.). For example, an embodiment may: emit a predetermined sound, provide a phrase indicating that the gesture recognition module is now active, etc. The foregoing notification methods may be used alone or in combination.

Responsive to the activation of the gesture recognition module at 304, an embodiment may attempt to identify, at 305, whether any gesture input has been provided by the user. In the context of this application, gesture input may be any type of non-audible input that a user provides via movement of one or more body parts. As a non-limiting example, a gesture input may be a predetermined hand motion in which a user moves their hand in a specific pattern. In an embodiment, the gesture recognition module may attempt to identify recognizable gesture inputs by comparing detected motions (e.g., body motion, etc.) to a database comprising a listing of known or recognizable gestures. Responsive to determining that a detected motion shares a predetermined level of similarity (e.g., 50% similarity, 75% similarity, etc.) with a recognizable gesture in the database, an embodiment may conclude that the detected motion corresponds to a recognizable gesture.

Responsive to not identifying, at 305, any recognizable gesture inputs, an embodiment may, at 306, do nothing. Additionally or alternatively, an embodiment may notify a user that no gesture input has been received or was able to be identified. Additionally or alternatively, an embodiment may deactivate the gesture recognition module if no gesture inputs have been identified within a predetermined period of time and may notify the user of that fact. Conversely, responsive to identifying, at 305, a recognizable gesture input, an embodiment may perform, at 307, a corresponding action based on the gesture. In an embodiment, each gesture input may be tied to a specific function of the device. Accordingly, when the gesture input is identified, an embodiment may perform that function. For example, for a device playing a particular playlist, the identification of a swipe gesture from the user may indicate that the user wants to skip to the next song.

In an embodiment, the gesture recognition module may only be primed to process gestures provided by a user whose gaze location is associated with the predetermined location. For example, a situation may occur where more than one individual may be present in a space. In such a situation, an embodiment may attempt to detect a gaze location associated with each user and thereafter only accept gesture inputs from the one or more users whose gaze locations corresponds to the predetermined location. In this situation, all other motions made by the other individuals whose gaze location does not correspond to the predetermined location may be ignored by an embodiment.

The various embodiments described herein thus represent a technical improvement to conventional gesture input provision techniques. Using the techniques described herein, an embodiment may detect a location of a user's gaze and determine whether that location corresponds to a predetermined location. Responsive to arriving at a positive determination, an embodiment may activate a gesture recognition module that may be used to receive and process gesture inputs from the user. Responsive to receiving one or more gesture inputs, an embodiment may thereafter perform a corresponding function. Such a method may prevent the unintentional provision of user gesture inputs to a device.

As will be appreciated by one skilled in the art, various aspects may be embodied as a system, method or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

It should be noted that the various functions described herein may be implemented using instructions stored on a device readable storage medium such as a non-signal storage device that are executed by a processor. A storage device may be, for example, a system, apparatus, or device (e.g., an electronic, magnetic, optical, electromagnetic, infrared, or semiconductor system, apparatus, or device) or any suitable combination of the foregoing. More specific examples of a storage device/medium include the following: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a storage device is not a signal and “non-transitory” includes all media except signal media.

Program code embodied on a storage medium may be transmitted using any appropriate medium, including but not limited to wireless, wireline, optical fiber cable, RF, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider), through wireless connections, e.g., near-field communication, or through a hard wire connection, such as over a USB connection.

Example embodiments are described herein with reference to the figures, which illustrate example methods, devices and program products according to various example embodiments. It will be understood that the actions and functionality may be implemented at least in part by program instructions. These program instructions may be provided to a processor of a device, a special purpose information handling device, or other programmable data processing device to produce a machine, such that the instructions, which execute via a processor of the device implement the functions/acts specified.

It is worth noting that while specific blocks are used in the figures, and a particular ordering of blocks has been illustrated, these are non-limiting examples. In certain contexts, two or more blocks may be combined, a block may be split into two or more blocks, or certain blocks may be re-ordered or re-organized as appropriate, as the explicit illustrated examples are used only for descriptive purposes and are not to be construed as limiting.

As used herein, the singular “a” and “an” may be construed as including the plural “one or more” unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

1. A method, comprising:
detecting, using at least one sensor of an information handling device, a gaze location of a user;
activating, responsive to detecting that the gaze location is directed at a predetermined location for a predetermined period of time, a gesture recognition module associated with the information handling device, wherein the predetermined location is associated with a portion of the information handling device;
providing a notification to the user that the gesture recognition module is active, wherein the providing comprises adjusting a visual characteristic of the predetermined location;
identifying, using the gesture recognition module, at least one gesture provided by the user;
associating the identified at least one gesture with at least one action, wherein the at least one action is dependent on an active application on the information handling device; and
performing, in the active application, the at least one action based on the at least one gesture.

2. (canceled)

3. The method of claim 1, wherein the detecting the gaze location of the user comprises detecting a head position of the user.

4.-5. (canceled)

6. The method of claim 1, wherein the user is associated with at least two users and wherein the detecting comprises detecting a gaze location of each of the at least two users.

7. The method of claim 6, wherein the activating comprises activating the gesture recognition module responsive to detecting that the gaze location of at least one user from the at least two users is directed at the predetermined location and wherein the identifying comprises identifying the at least one gesture from the at least one user.

8.-9. (canceled)

10. The method of claim 8, wherein the providing the notification further comprises playing an audible notification responsive to the gaze location being directed at the predetermined location.

11. An information handling device, comprising:
at least one sensor;
a gesture recognition module;
a processor;
a memory device that stores instructions executable by the processor to:
detect a gaze location of a user;
activate, responsive to detecting that the gaze location is directed at a predetermined location for a predetermined period of time, the gesture recognition module, wherein the predetermined location is associated with a portion of the information handling device;
provide a notification to the user that the gesture recognition module is active, wherein the providing comprises adjusting a visual characteristic of the predetermined location;
identify, using the gesture recognition module, at least one gesture provided by the user;
associate the identified at least one gesture with at least one action, wherein the at least one action is dependent on an active application on the information handling device; and
perform, in the active application, at least one action based on the at least one gesture.

12. The information handling device of claim 11, wherein the at least one sensor is selected from a group consisting of: an image capture device, a video capture device, a range imaging device, and a 3D scanning device.

13. The information handling device of claim 11, wherein the instructions executable by the processor to detect the gaze location of the user comprise instructions executable by the processor to detect a head position of the user.

14.-15. (canceled)

16. The information handling device of claim 11, wherein the user is associated with at least two users and wherein the instructions executable by the processor to detect comprise instructions executable by the processor to detect a gaze location of each of the at least two users.

17. The information handling device of claim 16, wherein the instructions executable by the processor to activate comprise instructions executable by the processor to activate the gesture recognition module responsive to detecting that the gaze location of at least one user from the at least two users is directed at the predetermined location and wherein the instructions executable the processor to identify comprise instructions executable by the processor to identify the at least one gesture from the at least one user.

18.-19. (canceled)

20. A computer program product, comprising:
a non-transitory computer readable storage medium having computer readable program code embodied therewith, the computer readable program code executable by a processor and comprising:
computer readable program code that detects a gaze location of a user;
computer readable program code that activates, responsive to detecting that the gaze location is directed at a predetermined location for a predetermined period of time, a gesture recognition module, wherein the predetermined location is associated with a portion of the information handling device;
computer readable program code that provides a notification to the user that the gesture recognition module is active, wherein the providing comprises adjusting a visual characteristic of the predetermined location;
computer readable program code that identifies, using the gesture recognition module, at least one gesture provided by the user;
computer readable program code that associates the identified at least one gesture with at least one action, wherein the at least one action is dependent on an active application on the information handling device; and
computer readable program code that performs, in the active application, at least one action based on the at least one gesture.
